(19) United States
(12) Patent Application Publication
(10) Pub. No.: US 2024/0196280 A1
(43) Pub. Date: Jun. 13, 2024

(54) CELL HANDOVER METHOD AND APPARATUS, AND STORAGE MEDIUM, USER EQUIPMENT AND BASE STATION DEVICE

(71) Applicant: SPREADTRUM COMMUNICATIONS (SHANGHAI) CO., LTD., Shanghai (CN)

(72) Inventor: Yun DENG, Shanghai (CN)

(21) Appl. No.: 18/551,911

(22) PCT Filed: Mar. 8, 2022
(86) PCT No.: PCT/CN2022/079634

§ 371 Date: Sep. 22, 2023

(30) Foreign Application Priority Data
Mar. 23, 2021 (CN) 202110310720.8

(51) Int. Cl. H04W 36/00; H04W 36/08; H04W 36/36

(52) U.S. Cl. CPC H04W 36/0011; H04W 36/0055; H04W 36/08; H04W 36/362

(57) ABSTRACT

A cell change method and apparatus, a storage medium, a user equipment and a base station device are provided. The cell change method includes: receiving configuration of candidate cells and indication information; determining the candidate cell that meets a change condition as a target cell or receiving a change command to determine the target cell, and performing cell change; and determining to save the configuration of other candidate cells based on the indication information, wherein the other candidate cells include the candidate cells other than the target cell, and the saved configuration of the other candidate cells is used for subsequent conditional change.

### CROSS-REFERENCE TO RELATED APPLICATIONS

This is the U.S. national stage of application No. PCT/CN2022/079634, filed on Mar. 8, 2022. Priority under 35 U.S.C. § 119(a) and 35 U.S.C. § 365(b) is claimed from Chinese Application No. 202110310720.8, filed Mar. 23, 2021, the disclosure of which is also incorporated herein by reference.

### TECHNICAL FIELD

The present disclosure generally relates to communication technology field, and more particularly, to a cell change method and apparatus, a storage medium, a User Equipment (UE) and a base station device.

### BACKGROUND

In a new radio communication system, a terminal can access the Internet through an Access Point (AP), and Long Term Evolution (LTE) or New Radio (NR) technology is adopted between the terminal and the AP. The AP may be integrated with a part of core network functions and may be deployed in licensed spectrum or unlicensed spectrum. The AP may be flexibly deployed in places such as homes or enterprises to provide service for a small number of users. The AP serves relatively few users which may be stable.

A conditional change mechanism is introduced into radio communication. A greatest difference between this change procedure and an original change procedure lies in that a conditional change command contains a change condition (change execution condition), such as determining whether signal quality of a candidate target cell is higher than that of a serving cell by a predetermined offset. After receiving the conditional change command, a UE determines whether a change execution condition is met. If the change execution condition is met, the UE accesses a target cell using configuration parameters of the candidate target cell included in the change command and synchronize with the target cell. The UE initiates a random access procedure in the target cell and implements change to the target cell after a change completion command is sent (that is, RRC reconfiguration is completed). If the change execution condition is not met, the UE continues to maintain an RRC connection with a source base station. The source base station may configure multiple candidate target cells and corresponding change execution conditions.

### SUMMARY

Embodiments of the present disclosure may enable a quick cell change.

In an embodiment of the present disclosure, a cell change method is provided, including: receiving configuration of candidate cells and indication information: determining the candidate cell that meets a change condition as a target cell or receiving a change command to determine the target cell, and performing cell change: and determining to save the configuration of other candidate cells based on the indication information, wherein the other candidate cells include the candidate cells other than the target cell, and the saved configuration of the other candidate cells is used for subsequent conditional change.

In an embodiment of the present disclosure, a storage medium having computer instructions stored therein is provided, wherein when the computer instructions are executed by a processor, the above method is performed.

In an embodiment of the present disclosure, a UE which includes a memory, and a processor is provided, wherein the memory has computer instructions stored therein, and when the processor executes the computer instructions, the above method is performed.

### BRIEF DESCRIPTION OF THE DRAWINGS

FIG. 1 is a flow chart of a cell change method according to an embodiment:

FIG. 2 is a flow chart of a cell change method according to an embodiment:

FIG. 3 is a diagram of a cell change method in a specific scenario according to an embodiment:

FIG. 4 is a structural diagram of a cell change apparatus according to an embodiment; and

FIG. 5 is a structural diagram of a cell change apparatus according to an embodiment.

### DETAILED DESCRIPTION

As described in the background, according to the existing conditional change mechanism, after the UE changes to the target cell, the UE needs to delete saved configuration of other candidate cells and reconfigure the candidate cells at each change. In addition, in unlicensed spectrum deployment, a change signaling may not be transmitted to the UE in time, resulting in a change failure.

Inventors of the present disclosure found through research that a newly introduced AP, such as deployed in home or company, may be deployed in an unlicensed spectrum, and include multiple adjacent serving cells, and a UE always move in these cells. After the UE adopts the conditional change mechanism and implements change, there is no need to release saved configuration of candidate cells, as the UE is likely to perform change between these cells later. Therefore, the existing conditional change mechanism may be improved, so that the UE can make full use of the configuration of the candidate cells configured by a network.

In the embodiments of the present disclosure, when receiving configuration of candidate cells, a UE also receives indication information which indicates whether the UE needs to save the configuration of the candidate cells, so that the UE saves the configuration of the candidate cells other than a target cell based on the indication information after performing cell change, to make it unnecessary for a network side to reconfigure candidate cells when subsequent cell change is required. Instead, the UE may directly perform cell change based on the saved configuration of the candidate cells, thereby reducing signaling overhead and effectively improving spectrum efficiency.

Further, in the embodiments of the present disclosure, a cell frequently used by the UE, i.e., a cell range where the UE usually moves, can be determined based on the access time of the UE. Accordingly, the UE may be indicated to save the configuration of the cell, so as to realize accessing using the configuration of the cell in time when changing to the cell.

The technical solutions of the present disclosure can be applied to 5G, 4G or 3G communication systems, and various new communication systems in the future, such as 6G and 7G communication systems.

In order to clarify the objects, characteristics and advantages of the disclosure, embodiments of present disclosure will be described in detail in conjunction with accompanying drawings.

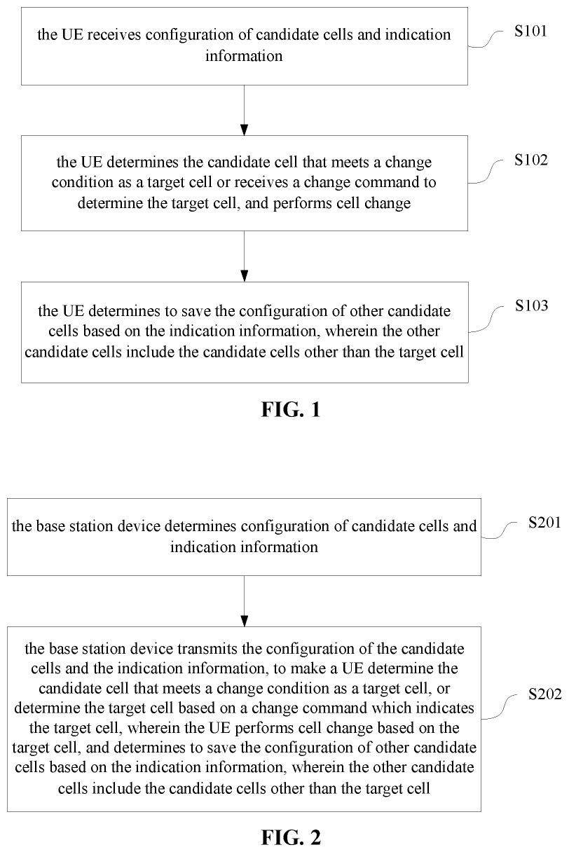

Referring to FIG. 1, FIG. 1 is a flow chart of a cell change method according to an embodiment.

In the embodiment, the cell change (i.e., cell handover) method may be applied to a UE side, that is, each step of the method may be performed by a UE. The UE may be various appropriate terminal devices, such as a mobile phone, a computer, or a tablet computer. A base station device interacting with the UE may be a base station in a traditional communication network or may be an AP device capable of providing a base station function, which is not limited in the embodiments of the present disclosure.

Specifically, the cell change method may include S101, S102 and S103.
In S101, the UE receives configuration of candidate cells and indication information;
In S102, the UE determines the candidate cell that meets a change condition as a target cell or receives a change command to determine the target cell and performs cell change.
In S103, the UE determines to save the configuration of other candidate cells based on the indication information, wherein the other candidate cells include the candidate cells other than the target cell.

It should be noted that sequence numbers of steps in the embodiment do not represent a limitation on an execution order of the steps.

A base station device, such as a traditional base station or an AP device, provides radio services in homes or companies, and is usually deployed with multiple serving cells in order to achieve coverage. In the embodiment, the base station device may include four serving cells including Cell1, Cell2, Cell3 and Cell4, where each base station device may serve one cell, or one base station device may serve multiple cells. The UE accesses Cell1 to be in a connected state. Due to movement of the UE, the base station device configures a conditional change mechanism for the UE, which may include configuration of the other three candidate cells.

In some embodiments, in S101, the base station device transmits the indication information when transmitting the configuration of the candidate cells to the UE, where the indication information indicates whether the UE needs to save the configuration of the candidate cells after change. Specifically, a signaling carrying the configuration of the candidate cells may be a conditional change command, for example, Radio Resource Control (RRC) signaling.

Specifically, the configuration of the candidate cells may include identities of the candidate cells and change conditions (i.e., change execution conditions) corresponding to the candidate cells. The change execution conditions corresponding to different candidate cells may be the same or different.

In some embodiments, in S102, the UE may evaluate whether each candidate cell meets the change condition, for example, determining whether signal quality of the candidate cell is higher than signal quality of a serving cell by a predetermined offset. In response to the candidate cell meeting the change condition, the UE accesses the candidate cell as the target cell. Specifically, the UE may use relevant parameters in the configuration of the candidate cell to complete accessing, synchronize with the target cell, initiate a random access procedure in the target cell, and implement change to the target cell after completing RRC reconfiguration.

When evaluating the candidate cells, the UE may receive a traditional change command from the base station device, where the traditional change command includes the target cell, and the UE performs change based on the target cell in the change command. In addition, the traditional change command may also include indication information, such as update indication information or newly setting indication information. When the UE merely receives the configuration of the candidate cells but no target cell in S101, the UE may obtain indication information from the traditional change command.

It should be noted that more specific implementation manners of cell change may be referred to the existing techniques and are not repeated here.

In some embodiments, in S103, the UE determines to save the configuration of other candidate cells based on the indication information, wherein the other candidate cells include the candidate cells other than the target cell, and the saved configuration of the other candidate cells is used for subsequent conditional change. That is, by saving the configuration of the other candidate cells, the configuration of the other candidate cells can be obtained in time during the subsequent change, which simplifies a subsequent cell change procedure.

For example, the base station configures three candidate cells Cell2, Cell3 and Cell4 for the UE. After the UE changes from Cell1 to Cell2, remaining candidate cells (that is, the other candidate cells) are Cell3 and Cell4. The UE determines to save configuration of Cell3 and Cell4 based on the indication of the base station.

In some embodiments, the cell change method may further include determining whether the candidate cell that meets the change condition exists based on configuration of candidate cells that has been saved: and determining the candidate cell that meets the change condition as the target cell, and performing cell change, in response to the candidate cell that meets the change condition existing.

Compared with a need of configuring candidate cells through a change command for each change in the existing techniques, in the embodiments of the present disclosure, it is unnecessary for a network side to reconfigure candidate cells when subsequent cell change is required. Instead, the UE may directly perform cell change based on the saved configuration of the candidate cells, thereby reducing signaling overhead and effectively improving spectrum efficiency.

In some embodiments, the indication information is received while receiving the configuration of the candidate cells, and the configuration of the candidate cells and the indication information are carried in a same signaling.

In the embodiments, the indication information is transmitted by sharing the signaling for transmitting the configuration of the candidate cells, which does not cause extra signaling overhead.

In some embodiments, the indication information is an independent information element for each candidate cell and indicates whether to save the configuration of the candidate cell.

In some embodiments, when configuring the independent information element for each candidate cell, the base station device may find that the UE usually moves in these candidate cells. Consequently, the base station device may indicate the UE not to release the configuration of these candidate cells after change.

Specifically, the independent information element may be a newly added bit in an RRC signaling. For example, if the bit value is 1, it means saving: otherwise, if the bit value is 0, it means not saving. For each candidate cell, there is one new bit corresponding to it.

Accordingly, if the independent information elements for the other candidate cells all indicate saving, the configuration of the other candidate cells is saved. For example, the base station device uses an independent information element to indicate to save the configuration of the candidate cells Cell2, Cell3, and Cell4 after change. After changing from Cell1 to Cell2, the UE determines to save the configuration of Cell3 and Cell4 based on indication of the independent information elements.

In some embodiments, the indication information includes an effective area.

In some embodiments, the effective area includes a cell list or a tracking area list.

Accordingly, it is determined whether the target cell or the other candidate cells belong to the effective area: if yes, the configuration of the other candidate cells is saved. That is, if the target cell or the other candidate cells belong to the effective area, it means that the network side corresponding to the above cell has saved context of the UE. Thus, by saving the configuration of the above cells, the UE can directly use the configuration of the candidate cells for change evaluation during subsequent conditional change, without interaction between a source base station and a target base station, thereby saving signaling overhead.

In some embodiments, after the change, the UE determines whether to save the configuration of the corresponding candidate cells based on whether the target cell after the change belongs to the effective area configured by the base station device. For example, the effective area may be Cell1, Cell2, Cell3 and Cell4. When the UE changes to Cell2, the UE finds that a new serving cell belongs to the effective area, thus, the UE saves the configuration of other candidate cells (Cell3 and Cell4).

Accordingly, if the UE changes to another target cell that does not belong to the effective area, the UE releases the configuration of the candidate cells after the change.

In some embodiments, the UE may continue to move, for example, when moving to a boundary of Cell3, the UE may use the saved configuration of Cell3 and the corresponding change condition to determine whether Cell3 meets the change condition and perform change if it is determined that Cell3 meets the change condition. Through the method provided in the embodiments, movement of the UE between multiple cells is realized with less signaling overhead, and spectrum efficiency may be effectively improved.

In some embodiments, in addition to saving the configuration of the other candidate cells, the UE may also save configuration of a source serving cell before change as the configuration of the candidate cells.

In some embodiments, referring to FIG. 2, the cell change method may be used at a base station device side, that is, the base station device may perform each step of the method. The base station device may be a base station in a traditional communication network or may be an AP device capable of providing a base station function, which is not limited in the embodiments of the present disclosure.

Specifically, the cell change method may include S201 and S202.
In S201, the base station device determines configuration of candidate cells and indication information.
In S202, the base station device transmits the configuration of the candidate cells and the indication information, to make a UE determine the candidate cell that meets a change condition as a target cell, or determine the target cell based on a change command which indicates the target cell, wherein the UE performs cell change based on the target cell, and determines to save the configuration of other candidate cells based on the indication information, wherein the other candidate cells include the candidate cells other than the target cell.

Further, S201 may include: determining based on historical access information of the UE that a number of times the UE accesses a first cell reaches a preset threshold; and indicating in the indication information to save configuration of the first cell.

In the embodiments, the historical access information of the UE records information of each cell accessed by the UE. The base station device configures that the first cell whose access times with the UE reach a preset threshold needs to be saved, that is, it is configured that the cell the UE frequently accesses needs to be saved, so as to avoid saving a large number of unnecessary cell configuration at the UE side, thereby saving a storage space of the UE.

In some embodiments, the base station device generally provides network services in a specific area, for example, APs generally provide wireless services in homes or companies, and the base station device may include multiple serving cells. The UE has a corresponding identity, such as a company employee, and has a binding relationship with the base station device and a serving cell of the base station device. Accordingly, the base station device determines an identity of a second cell according to the identity of the UE and the serving cell bound to it, where the second cell is a candidate cell to be saved and indicates in the indication information to save configuration of the second cell. For example, UE1 is bound to Cell1, Cell2, Cell3 and Cell4 contained in an AP of a company, then the AP can configure for UE1 that configuration of Cell1, Cell2, Cell3 and Cell4 needs to be saved.

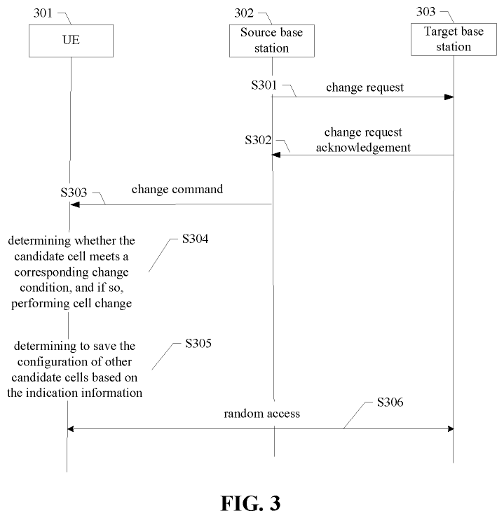

In a specific application scenario, referring to FIG. 3, FIG. 3 is a diagram of a cell change method in the specific scenario according to an embodiment.
In S301, a source base station 302 transmits a change request to a target base station 303.
In S302, the target base station 303 transmits a change request acknowledgement to a source base station 302.
In S303, the source base station 302 transmits a change command to a UE 301, wherein the change command includes configuration of each candidate cell and indication information.
In S304, the UE 301 determines whether the candidate cell meets a corresponding change condition, and if so, performs cell change.
In S305, the UE 301 determines to save the configuration of other candidate cells based on the indication information, wherein the other candidate cells include the candidate cells other than the target cell.
In S306, the UE 301 initiates random access to the target base station 303.

In subsequent steps, the UE 301, and the target base station 303 complete RRC reconfiguration, and the UE 301 completes change of the target cell.

It should be noted that S301 to S306 belong to a cell change procedure performed before the UE 301 saves the candidate cells. After the UE 301 saves the configuration of the candidate cells, if a cell change procedure is required, the above steps S301, S302 and S303 can be omitted. Therefore, the embodiments of the present disclosure enable UE's movement among multiple cells with less signaling overhead.

Referring to FIG. 4, FIG. 4 is a structural diagram of a cell change apparatus 40 according to an embodiment. The cell change apparatus 40 includes a receiving circuitry 401, a changing circuitry 402 and a saving circuitry 403.

The receiving circuitry 401 is configured to receive configuration of candidate cells and indication information. The changing circuitry 402 is configured to: determine the candidate cell that meets a change condition as a target cell or receive a change command to determine the target cell and perform cell change. The saving circuitry 403 is configured to determine to save the configuration of other candidate cells based on the indication information, wherein the other candidate cells include the candidate cells other than the target cell.

In the embodiments of the present disclosure, the UE saves the configuration of the candidate cells other than the target cell based on the indication information after performing cell change, to make it unnecessary for a network side to reconfigure candidate cells when subsequent cell change is required. Instead, the UE may directly perform cell change based on the saved configuration of the candidate cells, thereby reducing signaling overhead and effectively improving spectrum efficiency.

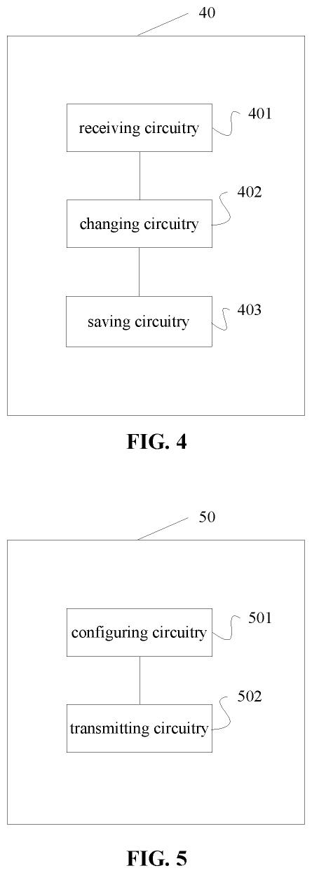

Referring to FIG. 5, FIG. 5 is a structural diagram of a cell change apparatus 50 according to an embodiment. The cell change apparatus 50 includes a configuring circuitry 501 and a transmitting circuitry 502.

The configuring circuitry 501 is configured to determine configuration of candidate cells and indication information. The transmitting circuitry 502 is configured to transmit the configuration of the candidate cells and the indication information, to make a UE determine the candidate cell that meets a change condition as a target cell, or determine the target cell based on a change command which indicates the target cell and is transmitted by the transmitting circuitry, wherein the UE performs cell change based on the target cell, and determines to save the configuration of other candidate cells based on the indication information, wherein the other candidate cells include the candidate cells other than the target cell.

The configuring circuitry 501 may include: a first cell determining circuitry (not shown in FIG. 5) configured to determine based on historical access information of the UE that a number of times the UE accesses a first cell reaches a preset threshold; and a configuring circuitry (not shown in FIG. 5) configured to indicate in the indication information to save configuration of the first cell.

More details of working principles and working modes of the cell change apparatus 40 and the cell change apparatus 50 can be referred to related descriptions in FIG. 1 to FIG. 3 and are not repeated here.

The cell change apparatus 40 and the cell change apparatus 50 may be a chip or a chip module.

Each module/unit of each apparatus and product described in the above embodiments may be a software module/unit or a hardware module/unit or may be a software module/unit in part, and a hardware module/unit in part. For example, for each apparatus or product applied to or integrated in a chip, each module/unit included therein may be implemented by hardware such as circuits: or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a storage medium having computer instructions stored therein is provided, wherein when the computer instructions are executed, the cell change method as shown in FIG. 1 to FIG. 3 is performed. In some embodiments, the storage medium may include a ROM, a RAM, a magnetic disk, or an optical disk. In some embodiments, the storage medium may include a non-volatile or a non-transitory memory.

In an embodiment of the present disclosure, a UE including a memory and a processor is provided, wherein the memory has computer instructions stored therein, and when the processor executes the computer instructions, the cell change method as shown in FIG. 1 or FIG. 3 is performed. The UE may include but not limited to a mobile phone, a computer or a tablet computer.

In an embodiment of the present disclosure, a base station device including a memory and a processor is provided, wherein the memory has computer instructions stored therein, and when the processor executes the computer instructions, the cell change method as shown in FIG. 2 or FIG. 3 is performed.

The technical solutions of the present disclosure also may be applied to different network architectures, including but not limited to a relay network architecture, a dual-link architecture, and a vehicle-to-everything architecture.

In the embodiments of the present disclosure, a core network may be an Evolved Packet Core (EPC), 5G Core Network or a new core network in future communication systems. The 5G Core Network is composed of a set of devices, implements Access and Mobility Management Function (AMF) providing functions such as mobility management function, User Plane Function (UPF) providing functions such as packet routing and forwarding and Quality of Service (QOS) management, and Session Management Function (SMF) providing functions such as session management and IP address allocation and management. The EPC may consist of an MME that provides functions such as mobility management and gateway selection, a Serving Gateway (S-GW) that provides functions such as packet forwarding, and a PDN Gateway (P-GW) that provides functions such as terminal address allocation and rate control.

The base station in the embodiments of the present disclosure may also be referred to as a base station equipment, and is a device deployed in a wireless access network to provide wireless communication functions. For example, an equipment that provides a base station function in a 2G network includes a Base Transceiver Station (BTS) and a Base Station Controller (BSC). An equipment that provides the base station function in a 3G network includes a Node B and a Radio Network Controller (RNC). An equipment that provides the base station function in a 4G network includes an evolved node B (eNB). In a Wireless Local Area Network (WLAN), an equipment that provides the base station function is an Access Point (AP). An equipment that provides the base station function in a 5G New Radio (NR) includes gNB and a continuously evolved Node B (ng-eNB), where gNB and the terminal use NR technology for communication, ng-eNB and the terminal use Evolved Universal Terrestrial Radio Access (E-UTRA) technology for communication, and both gNB and ng-eNB can be connected to a 5G core network. And the base station also refers to an equipment that provides the base station function in a new communication system in the future.

The base station controller in the embodiments of the present disclosure is a device for managing base stations, such as a Base Station Controller (BSC) in a 2G network, a Radio Network Controller (RNC) in a 3G network, or a device that controls and manages a base station in a new communication system in the future.

The network in the embodiments of the present disclosure refers to a communication network that provides communication services for terminals, including a base station of a radio access network, a base station controller of a radio access network, and a device on a core network side.

A terminal in the embodiments of the present disclosure may refer to various forms of UE, access terminal, user unit, user station, Mobile Station (MS), remote station, remote terminal, mobile equipment, user terminal, terminal equipment, wireless communication equipment, user agent or user device. The terminal equipment may further be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modems, an in-vehicle device, a wearable device, a terminal equipment in the future 5G network, or a terminal equipment in a future evolved Public Land Mobile Network (PLMN), which is not limited in the embodiments of the present disclosure.

In the embodiments of the present disclosure, a unidirectional communication link from an access network to a terminal is defined as a downlink, data transmitted on the downlink is downlink data, and a transmission direction of the downlink data is called a downlink direction. Besides, a unidirectional communication link from a terminal to an access network is defined as an uplink, data transmitted on the uplink is uplink data, and a transmission direction of the uplink data is called an uplink direction.

It should be understood that the term “and/or” in the present disclosure is merely an association relationship describing associated objects, indicating that there can be three types of relationships, for example, A and/or B can represent “A exists only, both A and B exist, B exists only. In addition, the character “/” in the present disclosure represents that the former and latter associated objects have an “or” relationship.

The “plurality” in the embodiments of the present disclosure refers to two or more.

The descriptions of the first, second, etc. in the embodiments of the present disclosure are merely for illustrating and differentiating the objects, and do not represent the order or the particular limitation of the number of devices in the embodiments of the present disclosure, which do not constitute any limitation to the embodiments of the present disclosure.

The “connection” in the embodiments of the present disclosure refers to various connection ways such as direct connection or indirect connection to realize communication between devices, which is not limited in the embodiments of the present disclosure.

In the embodiments of the present disclosure, the processor may be a Central Processing Unit (CPU), or other general processors, Digital Signal Processors (DSPs), Application Specific Integrated Circuits (ASICs), Field Programmable Gate Arrays (FPGAs) or other Programmable logic devices, discrete gates or transistor logic devices, discrete hardware components, and the like. A general processor may be a microprocessor, or the processor may be any conventional processor or the like.

It should also be understood that the memory in the embodiments of the present disclosure may be either volatile memory or nonvolatile memory or may include both volatile and nonvolatile memories. The non-volatile memory may be a Read-Only Memory (ROM), a Programmable ROM (PROM), an Erasable PROM (EPROM), an electrically Erasable EPROM (EEPROM), or a flash memory. The volatile memory may be a Random Access Memory (RAM) which functions as an external cache. By way of example but not limitation, various forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced SDRAM (ESDRAM), Synchronous connection to DRAM (SLDRAM), and Direct Rambus RAM (DR-RAM).

The above embodiments may be implemented in whole or in part by software, hardware, firmware or any combination thereof. When implemented in software, the above embodiments may be implemented in whole or in part in the form of a computer program product. The computer program product includes one or more computer instructions or computer programs. The procedures or functions according to the embodiments of the present disclosure are wholly or partially generated when the computer instructions or the computer programs are loaded or executed on a computer. The computer may be a general-purpose computer, a special purpose computer, a computer network, or other programmable device. The computer instructions may be stored in a computer readable storage medium or transmitted from one computer readable storage medium to another computer readable storage medium, for example, the computer instructions may be transmitted from one website, computer, server or data center to another website, computer, server or data center by wire (e.g., infrared, wireless, microwave and etc.). The computer readable storage medium may be any available medium that can be accessed by a computer or a data storage device such as a server or a data center that contains one or more sets of available media. The available medium may be a magnetic medium (e.g., floppy disk, hard disk or magnetic tape), an optical medium (e.g., DVD), or a semiconductor medium. The semiconductor medium may be a solid disk.

It should be understood that, in the various embodiments of the present disclosure, sequence numbers of the above-mentioned processes do not represent an execution sequence, and the execution sequence of each process should be determined by its function and inherent logic, which does not limit an implementation process of the embodiments of the present disclosure.

In the above embodiments of the present disclosure, it should be understood that the disclosed method, device and system may be implemented in other ways. For example, the above device embodiments are merely illustrative, and for example, division of units is merely one logical division, and other divisions may be realized in practice, for example, a plurality of units or components may be combined or integrated into another system, or some features may be omitted, or not executed. Further, the shown or discussed mutual coupling or direct coupling or communication connection may be an indirect coupling or communication connection via some interfaces, devices, or units, and may be in an electrical, mechanical or other form.

The units described as separate parts may or may not be physically separate, and parts shown as units may or may not be physical units, that is, may be disposed in one place, or may be distributed on a plurality of network units. Some or all of the units can be selected according to practical requirements to achieve the purpose of the solutions of the embodiments.

In addition, functional units in the embodiments of the present disclosure may be integrated in one processing unit, or each unit may be physically separate, or two or more units may be integrated in one unit. The integrated units can be realized in a form of hardware, or in a form of hardware plus a software functional unit.

The integrated units implemented in the form of the software functional unit may be stored in a computer readable storage medium. The software functional unit is stored in a storage medium and includes several instructions for causing a computer device (a personal computer, a server, or a network device) to execute some steps of the methods in the embodiments of the present disclosure. And the storage medium may be a medium for storing program codes, such as a U disk, a removable hard disk, a ROM, a RAM, a magnetic disk, or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1. A cell change method, comprising:
receiving configuration of candidate cells and indication information;
determining the candidate cell that meets a change condition as a target cell or receiving a change command to determine the target cell, and performing cell change; and
determining to save the configuration of other candidate cells based on the indication information, wherein the other candidate cells comprise the candidate cells other than the target cell, and the saved configuration of the other candidate cells is used for subsequent conditional change.

2. The cell change method according to claim 1, wherein said receiving configuration of candidate cells and indication information comprises:
receiving the configuration of the candidate cells along with the indication information, wherein the configuration of the candidate cells and the indication information are carried in a same signaling.

3. The cell change method according to claim 1, wherein the indication information is an independent information element for each candidate cell which indicates whether to save the configuration of the candidate cell.

4. The cell change method according to claim 3, wherein said determining to save the configuration of the other candidate cells based on the indication information comprises:
based on that the independent information elements for the other candidate cells all indicate saving configuration, saving the configuration of the other candidate cells.

5. The cell change method according to claim 1, wherein the indication information comprises an effective area.

6. The cell change method according to claim 5, wherein the effective area comprises a cell list or a tracking area list.

7. The cell change method according to claim 5, wherein said determining to save the configuration of the other candidate cells based on the indication information comprises:
determining whether the target cell or the other candidate cells belong to the effective area; and
based on that the target cell or the other candidate cells belong to the effective area, saving the configuration of the other candidate cells.

8. The cell change method according to claim 1, further comprising:
saving configuration of a source serving cell before change as the configuration of the candidate cells.

9. The cell change method according to claim 1, further comprising:
determining whether the candidate cell that meets the change condition exists based on configuration of candidate cells that has been saved; and
determining the candidate cell that meets the change condition as the target cell, and performing cell change, in response to the candidate cell that meets the change condition existing.

10. (canceled)

11. (canceled)

12. (canceled)

13. (canceled)

14. A non-transitory storage medium storing one or more programs, the one or more programs comprising computer instructions, which, when executed by a processor, cause the processor to:
receive configuration of candidate cells and indication information;
determine the candidate cell that meets a change condition as a target cell or receive a change command to determine the target cell, and perform cell change; and
determine to save the configuration of other candidate cells based on the indication information, wherein the other candidate cells comprise the candidate cells other than the target cell, and the saved configuration of the other candidate cells is used for subsequent conditional change.

15. A user equipment, comprising a memory and a processor, wherein the memory stores one or more programs, the one or more programs comprising computer instructions, which, when executed by the processor, cause the processor to:
receive configuration of candidate cells and indication information;
determine the candidate cell that meets a change condition as a target cell or receive a change command to determine the target cell, and perform cell change; and
determine to save the configuration of other candidate cells based on the indication information, wherein the other candidate cells comprise the candidate cells other than the target cell, and the saved configuration of the other candidate cells is used for subsequent conditional change.

16. (canceled)

17. The user equipment according to claim 15, wherein the processor is further caused to:
receive the configuration of the candidate cells along with the indication information, wherein the configuration of the candidate cells and the indication information are carried in a same signaling.

18. The user equipment according to claim 15, wherein the indication information is an independent information element for each candidate cell which indicates whether to save the configuration of the candidate cell.

19. The user equipment according to claim 18, wherein the processor is further caused to:
based on that the independent information elements for the other candidate cells all indicate saving configuration, save the configuration of the other candidate cells.

20. The user equipment according to claim 15, wherein the indication information comprises an effective area.

21. The user equipment according to claim 20, wherein the effective area comprises a cell list or a tracking area list.

22. The user equipment according to claim 20, wherein the processor is further caused to:
determine whether the target cell or the other candidate cells belong to the effective area; and
based on that the target cell or the other candidate cells belong to the effective area, save the configuration of the other candidate cells.

23. The user equipment according to claim 15, wherein the processor is further caused to:
save configuration of a source serving cell before change as the configuration of the candidate cells.

24. The user equipment according to claim 15, wherein the processor is further caused to:
determine whether the candidate cell that meets the change condition exists based on configuration of candidate cells that has been saved; and
determine the candidate cell that meets the change condition as the target cell, and perform cell change, in response to the candidate cell that meets the change condition existing.
